(19) United States
(12) Patent Application Publication
(10) Pub. No.: US 2008/0051126 A1
(43) Pub. Date: Feb. 28, 2008

(54) Method for allocating transmit power in a wireless communication system

(76) Inventors: Shirish Nagaraj, Cedar Knolls, NJ (US); Anil M. Rao, Cedar Knolls, NJ (US)

Correspondence Address: Lucent Technologies Inc.;Docket Administrator, Room 3J-219, 101 Crawfords Corner Road, Holmdel, NJ, 07733-3030, US

(21) Appl. No.: 11/507,877

(22) Filed: Aug. 22, 2006

(51) Int. Cl. H04B 7/00; H04Q 7/20

(52) U.S. Cl. 455/522

(57) ABSTRACT

Disclosed is a method of setting reverse link traffic and pilot transmit powers in a wireless communications system based on traffic channel activity in order to lower average total transmit power on the reverse link and optimize reverse link capacity. As traffic channel activity decreases, the traffic transmit power relative to the pilot transmit power, i.e., traffic-to-pilot ratio (TPR), should increase. Increasing TPR will produce lower pilot transmit powers and higher traffic transmit powers. Although higher traffic transmit powers are undesirable, the effect on average total transmit power is lessen because the traffic channel is not active all the time. By contrast, the pilot channel is always active and, thus, it is desirable to sacrifice some performance of channel estimation in order to lower average total transmit power.

### FIELD OF THE INVENTION

The present invention relates generally to wireless communication systems and, in particular, to setting reverse link transmit power in wireless communication systems.

### BACKGROUND OF THE INVENTION

Optimizing reverse link capacity of third generation (3G) based wireless communication systems, such as Universal Mobile Telecommunications System (UMTS) and Code Division Multiple Access 2000 (CDMA2000) systems, involves minimizing total transmit power for each reverse link. Total transmit power includes transmit powers for a pilot channel and a traffic channel. The transmit power of the traffic channel relative to the pilot channel is referred to herein as a traffic-to-pilot ratio (TPR).

The pilot transmit power is initially set based on a transmit power used by a mobile station to establish a connection with a base station over a random access channel (RACH). The initial pilot transmit power and a desired TPR are used to set the initial traffic transmit power. For example, if the desired TPR is 3:1, the traffic transmit power will initially be set to a level three times the level of the initial pilot transmit power.

After setting the initial transmit powers, the pilot and traffic transmit powers are adjusted in accordance with outer and inner loop power control techniques. Outer loop power control involves establishing a threshold signal-to-interference ratio (SIR) at which the pilot channel should be received at the base station, wherein the threshold SIR corresponds to a minimum SIR that achieves a desired error rate for the traffic channel. Outer loop power control will cause the threshold SIR to increase or decrease if the error rate of the traffic channel, measured over a time duration referred to as an “outer loop period”, is greater or less than the desired error rate, respectively.

Inner loop power control will cause the mobile station to increase or decrease its transmit power if the SIR of the pilot channel, measured at the base station over a time duration referred to as an “inner loop period”, is less or greater than the threshold SIR, respectively. The mobile station will adjust the transmit powers of the traffic and pilot channels proportionally in accordance with the desired TPR. For example, if the desired TPR is 3:1, then the amount of change in traffic transmit power will be three times the amount of change in the pilot transmit power.

To optimize reverse link capacity, the desired TPR should be one which minimizes total transmit power for the reverse link while achieving the desired error rate associated with outer loop power control. Such TPR is referred to herein as an “optimum TPR”. An optimum TPR will result in the traffic and pilot transmit powers being set, as a consequence of the power control loops, to optimum traffic and pilot transmit powers.

By contrast, a non-optimum TPR may be a TPR which is higher or lower than the optimum TPR. A high TPR may cause the pilot transmit power to be set lower than the optimum pilot transmit power, and the traffic transmit power to be set higher than the optimum traffic transmit power. Although a low pilot transmit power can cause poor channel estimations and poor performance of inner loop power control, a high traffic transmit power can compensate for these deficiencies such that the desired error rate is achieved. However, to compensate for the low pilot transmit power, the traffic transmit power needs to be increased over the optimum traffic transmit power an amount greater than the difference between the low and optimum pilot transmit powers, thereby resulting in an overall increase in total transmit power.

On the other hand, a low TPR may cause the pilot transmit power to be set higher than the optimum pilot transmit power, and the traffic transmit power to be set lower than the optimum traffic transmit power. A high pilot transmit power can improve channel estimation and/or inner loop power control performance which, in turn, allows the desired error rate to be achieved with a lower traffic transmit power. However, the amount the traffic transmit power can be decreased below the optimum traffic transmit power as a result of improved channel estimation and inner loop power control performance is less than the difference between the high and optimum pilot transmit powers, thereby resulting in an overall increase in total transmit power.

A prior art approach to determining the optimum TPR involves measuring total received power at a base station as a function of TPRs for an always active speech codec. The optimum TPR would be the TPR associated with the lowest total received power. FIG. 1 depicts a chart 100 illustrating a plot 110 of measurements corresponding to average total received power at the base station as a function of TPR for an always active 7.95 kbps Adaptive Multi-Rate (AMR) speech codec in an additive white Gaussian noise (AWGN) channel. The traffic channel is used to execute outer loop power control, which is configured to ensure a desired frame error rate of 1%. Plot 110 indicates the average total received power for a corresponding TPR which achieves the desired frame error rate. According to chart 100, the optimum TPR for achieving the desired frame error rate would be 4.2 dB corresponding to the lowest average total received power.

This approach for determining the optimum TPR assumes that the traffic channel is always active, i.e., the user of the mobile station is continuously speaking and, thus, is based on an always active speech codec. However, in most speech conversations, the mobile user is speaking approximately half the time and listening the other half of the time. In 3G systems, when the mobile user is speaking, the traffic channel and the pilot channel are both active, i.e., speech frames and a pilot signal (which may or may not include control bits) are being transmitted over the traffic and pilot channels, respectively. When the mobile user is not speaking, the traffic channel is inactive but the pilot channel will still be active. FIG. 2 depicts charts 200 and 210 illustrating transmission power levels associated with an always active speech codec and an intermittently active speech codec, respectively. As shown in charts 200 and 210, the pilot channel is always active.

Setting traffic and pilot transmit powers using a TPR based on an always active speech codec would not optimize reverse link capacity because, under real life conditions, the mobile user is not continuously speaking. Accordingly, there exists a need for setting reverse link traffic and pilot transmit powers for less than always active traffic channels.

### SUMMARY OF THE INVENTION

An embodiment of the present invention is a method for setting reverse link traffic and pilot transmit powers in a wireless communications system based on traffic channel activity in order to lower average total transmit power on the reverse link and optimize reverse link capacity. In accordance with one embodiment, as traffic channel activity decreases, a ratio between the traffic and pilot transmit powers, i.e., traffic-to-pilot ratio (TPR), should increase. Increasing TPR will produce lower pilot transmit powers and higher traffic transmit powers. Although higher traffic transmit powers are undesirable, the effect on average total transmit power is lessen because the traffic channel is not active all the time. By contrast, the pilot channel is always active and, thus, it may be desirable to sacrifice some performance of channel estimation in order to lower average total transmit power.

### BRIEF DESCRIPTIONS OF THE DRAWINGS

The features, aspects, and advantages of the present invention will become better understood with regard to the following description, appended claims, and accompanying drawings where:

FIG. 1 depicts a chart illustrating a plot of measurements corresponding to average total received power at the base station as a function of TPR for an always active speech codec;

FIG. 2 depicts two charts illustrating transmission power levels associated with an always active speech codec and an intermittently active speech codec;

FIG. 3 depicts a wireless communication system used in accordance with the present invention;

FIG. 4 depicts a flowchart illustrating a method of setting transmit power levels for the traffic and pilot channels in accordance with one embodiment of the present invention;

FIG. 5 depicts a chart illustrating a plot of measurements corresponding to average total received power at Node B for various levels of traffic channel activity as a function of traffic to pilot ratio (TPR); and

FIG. 6 depicts a table illustrating optimum TPRs for various levels of traffic channel activity.

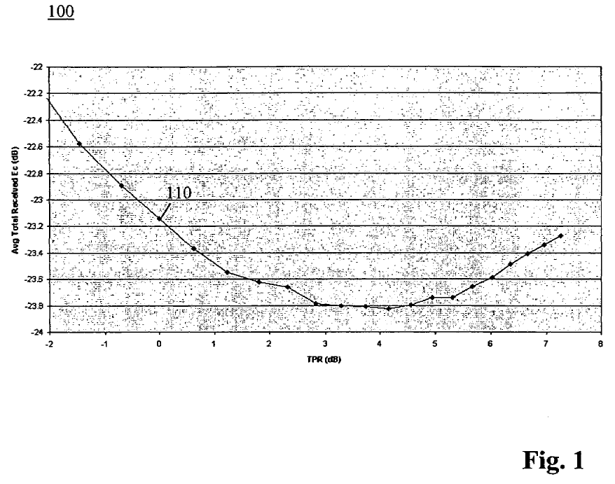

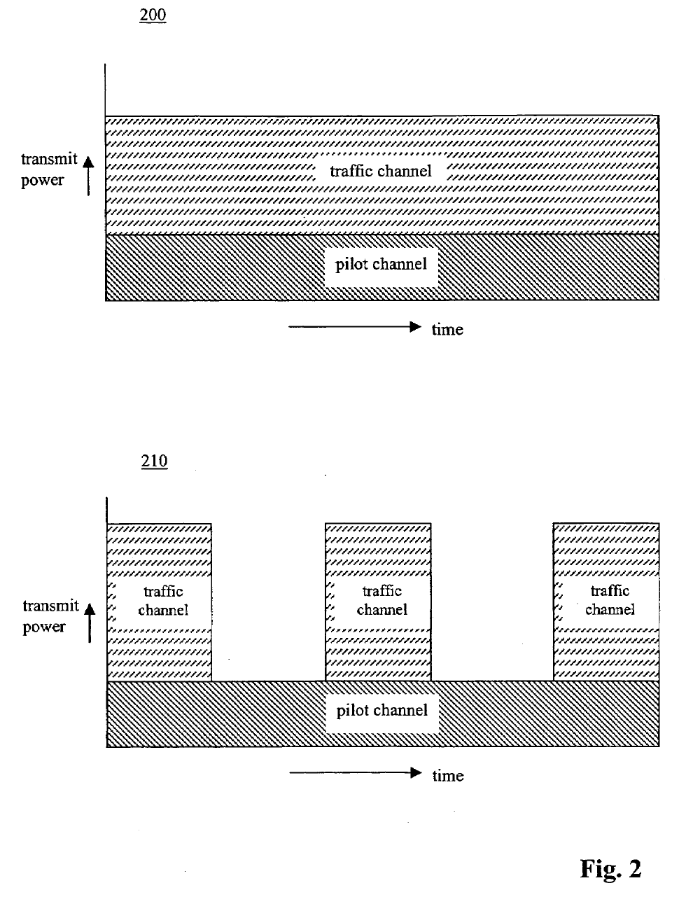

### DETAILED DESCRIPTION

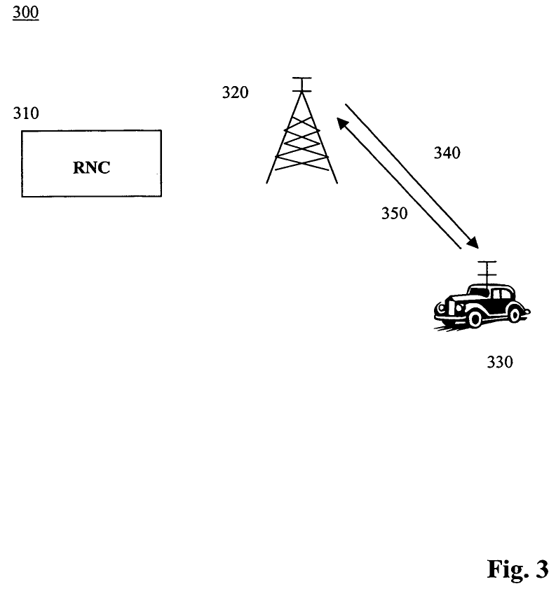

An embodiment of the present invention is a method of setting reverse link traffic and pilot transmit powers in a wireless communications system based on traffic channel activity in order to lower average total transmit power on the reverse link and optimize reverse link capacity. FIG. 3 depicts a wireless communication system 300 used in accordance with an embodiment of the present invention. Wireless communication system 300 can be, for example, a third generation (3G) wireless communication system based on Code Division Multiple Access (CDMA). Examples of such 3G systems include the well-known Universal Mobile Telecommunications System (UMTS) and CDMA2000 systems.

For illustration purposes, the present invention will be described herein with respect to voice applications in an UMTS system over a reverse link dedicated channel. It should be understood that the present invention may also be applicable to other types of applications, reverse or forward link shared channels, forward link dedicated channels, and similar wireless communication systems including, but not limited to, CDMA2000 systems.

Wireless communication system 300 comprises Radio Network Controller (RNC) 310, Node B 320 and User Equipment (UE) 330. RNC 310, Node B 320 and UE 330, also known as a base station controller, base station and mobile station, respectively, are well-known in the art. RNC 310 and UE 330 include a speech codec having a voice activity detector. Node B may also include a speech codec having a voice activity detector. Voice activity detectors are well-known in the art.

UE 330 communicates with Node B 320 over a forward link 340 and a reverse link 350. Forward link 340 being used for the transmission of signals from Node B 320 to UE 330. Reverse link 350 being used for the transmission of signals from UE 330 to Node B 320. Reverse link 350 includes a pilot channel and a traffic channel. For reverse link Dedicated CHannels (DCH) in UMTS, the pilot channel and traffic channel are referred to as a Dedicated Pilot Control CHannel (DPCCH) and Dedicated Physical Data CHannel (DPDCH), respectively. Pilot signals are transmitted over the DPCCH, and speech frames are transmitted over the DPDCH.

Transmit powers for the DPCCH and DPDCH are set based on traffic channel activity, among other things, as will be described later. For illustration purposes, the term “traffic channel activity” will be used to refer to an amount of activity on the DPDCH. The DPDCH can be described as active when speech frames (or data packets) are being transmitted or received over the DPDCH. By contrast, DPDCH can be described as inactive when speech frames (or data packets) are not being transmitted or received over the DPDCH.

Traffic channel activity can be measured using the active and inactive intervals of the DPDCH. In one embodiment, traffic channel activity can be measured as a ratio between active intervals on the traffic channel and active plus inactive intervals on the traffic channel. For example, a traffic channel activity of 1.0 would indicate that speech frames are always being transmitted over the traffic channel, whereas a traffic channel activity of 0.5 would indicate that speech frames are only being transmitted over the traffic channel half the time.

In most speech conversations, the traffic channel is not always active. When the UE user is speaking, speech frames are being sent over the DPDCH along with a pilot signal being sent over the DPCCH. When the UE user is not speaking, no speech frames are being sent over the DPDCH. However, the pilot signal will still be sent over the DPCCH in order for Node B 320 to maintain up-to-date channel estimations and to execute inner loop power control.

The present invention takes into account traffic channel activity when setting transmit powers for the DPCCH and DPDCH. In one embodiment, the traffic channel activity is used to select a traffic-to-pilot ratio (TPR) corresponding to a transmit power ratio between the DPDCH and DPCCH (or traffic and pilot channels). The selected TPR is subsequently used to set the transmit powers of the DPCCH and DPDCH.

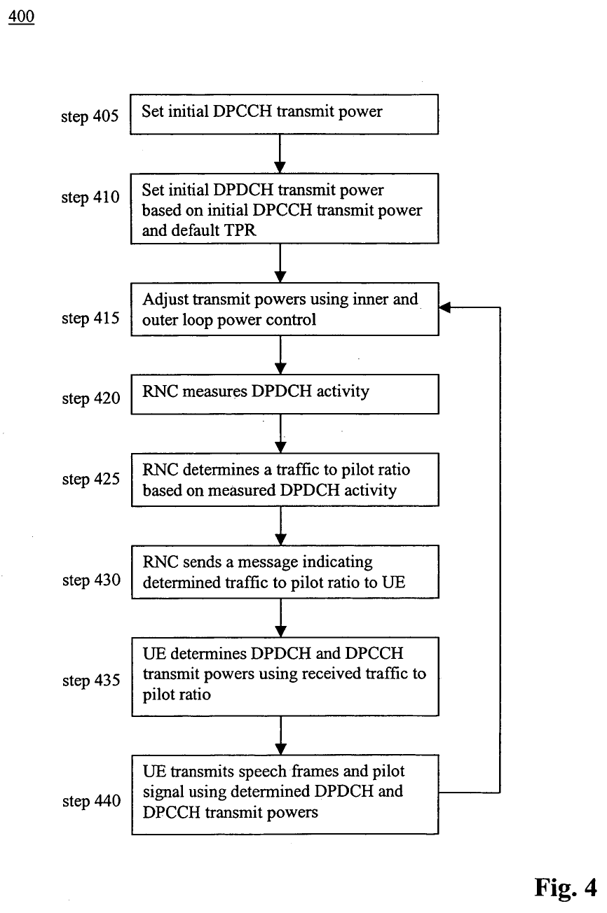

FIG. 4 depicts a flowchart 400 illustrating a manner of setting transmit powers for the pilot and traffic channels in accordance with an embodiment of the present invention. In step 405, RNC 310 sets an initial transmit power for the DPCCH. The transmit power for the DPCCH may, for example, be initially set based on a transmit power used by UE 330 to establish a connection with Node B 320 over a random access channel (RACH).

In step 410, the initial DPCCH transmit power and a default TPR are used to initially set the DPDCH transmit power. For example, if the default TPR is 3:1, the DPDCH transmit power will initially be set to a level three times the level of the initial DPCCH transmit power. Alternately, the initial DPCCH and DPDCH transmit powers may be set, for example, in accordance with default values, channel condition measurements, power control, transmit power of another channel and/or TPR.

In step 415, the DPCCH and DPDCH transmit powers are adjusted based on power control techniques. Power control techniques include outer and inner loop power control. Outer loop power control involves establishing a threshold signal-to-interference ratio (SIR) at which the DPCCH should be received at Node B 320, wherein the threshold SIR corresponds to a minimum SIR that achieves a desired error rate for the DPDCH. Outer loop power control will cause the threshold SIR to increase or decrease if the error rate of the DPDCH, measured over a time duration referred to as an “outer loop period”, is greater or less than the desired error rate, respectively.

Inner loop power control will cause UE 330 to increase or decrease its transmit power if the SIR of the DPCCH, measured at Node B 320 over a time duration referred to as an “inner loop period”, is less or greater than the threshold SIR, respectively. Node B 320 will indicate to UE 330, via a power control bits, whether to increase or decrease its transmit powers. UE 330 will adjust the transmit powers of the DPDCH and DPCCH proportionally in accordance with the TPR. For example, if the TPR is 3:1, then the amount of change in traffic transmit power will be three times the amount of change in the pilot transmit power. Note that the TPR used for inner loop power control can either be the default TPR or a TPR selected based on traffic channel activity. The TPR used for inner loop power control would be the default TPR until the TPR based on traffic channel activity is selected.

Steps 420 and 425 describes how a TPR is selected based on traffic channel activity. In step 420, RNC 310 measures activity on the DPDCH, i.e., traffic channel activity, associated with UE 330. Activity on the DPDCH may be determined or measured using the voice activity detector at RNC 310. The activity of the DPDCH may also be measured by the voice detector at Node B 320 or UE 330.

In an alternate embodiment, the activity on the DPDCH may be measured by using physical layer control information. For example, in UMTS, the DPCCH carries a Transport Format Combination Indicator (TFCI), which indicates the format of the data on the DPDCH. A zero TFCI codeword indicates that no data is sent on the DPDCH, and hence can be used to measure the activity of the DPDCH.

Other factors, such as physical channel types, may also affect how traffic channel activity is measured or determined. For example, Adaptive Multi-Rate (AMR) speech frames are transmitted over 20 ms transmission time intervals (TTI) on the DPDCH. For an always active AMR speech codec, the DPDCH would be active 100% of the time. By contrast, if the AMR speech frames were being transmitted as Voice over Internet Protocol (VoIP) over an Enhanced Dedicated Physical Data CHannel (E-DPDCH) which uses Hybrid Automatic Repeat reQuest (HARQ), the traffic channel (i.e., E-DPDCH) would not be active 100% of the time. In E-DPDCH, the AMR speech frame would be transmitted over a 2 ms TTI instead of a 20 ms TTI (as in DPDCH). Assuming the AMR speech codec is always active and an average of two transmissions, i.e., an initial transmission and a retransmission, is used for each AMR speech frame, the E-DPDCH would be active about 20% of the time, i.e., 2 ms/20 ms*2 transmissions=0.2.

In step 425, RNC 310 selects or determines a TPR based on the measured traffic channel activity. For different levels of traffic channel activity, a different TPR may be associated therewith which would minimize average total transmit power for the reverse link, i.e., optimum TPR. In one embodiment, the TPR is selected using a table associating traffic channel activity with optimum TPRs, wherein the table associates decreasing traffic channel activity with increasing optimum TPRs, and vice-versa.

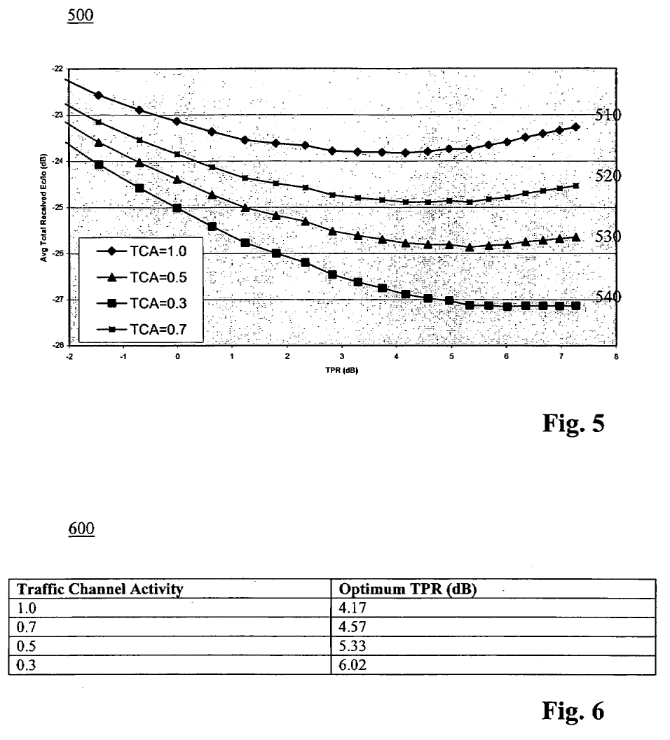

Selecting an optimum TPR for various levels of traffic channel activity, in one embodiment, involves measuring total received power at Node B. FIG. 5 depicts a chart 500 illustrating plots 510, 520, 530 and 540 associated with traffic channel activity levels 1.0, 0.7, 0.5 and 0.3 (or 100%, 70%, 50% and 30%), respectively. Chart 500 can be derived using a computer simulation tool which simulates a 7.95 kbps AMR speech codec in an additive white Gaussian noise (AWGN) channel. In the computer simulation, the DPDCH or traffic channel is used to execute an outer loop power control configured for the desired frame error rate of 1%. Chart 500 may also be derived, for example, by taking actual measurements of receive power at Node B under the same or different conditions used for the computer simulation tool.

Each plot 510, 520, 530 and 540 indicates the average total received power for a corresponding TPR which achieves a desired frame error rate of 1%. The optimum TPR for each traffic channel activity level would be the TPR associated with the lowest average total received power.

FIG. 6 depicts a table 600 illustrating optimum TPRs for various levels of traffic channel activity, as derived from chart 500. Table 600 may be used in step 425 to select an optimum TPR for a particular traffic channel activity. For example, if the traffic channel activity was 50% or 0.5, then the TPR of 5.33 dB is selected.

As shown in FIGS. 5 and 6, the optimum TPR increases as traffic channel activity decreases. Increasing TPR when traffic channel activity decreases results in a lower average total transmit power due to a lower pilot channel or DPCCH transmit power. Increasing TPR will result in a lower pilot transmit power and a higher traffic transmit power. Although high traffic transmit power is undesirable, the effect on average total transmit power is lessen because the traffic channel is not active all the time. By contrast, the pilot channel is always active and, thus, it is desirable to sacrifice some performance of channel estimation in order to lower average total transmit power. The overall effect is lower average total transmit power.

Returning to flowchart 400, in step 430, RNC 310 sends to UE 330 (via Node B 320) a message indicating the selected TPR, or the message may indicate to UE 330 some other manner for setting its transmit powers. In step 435, UE 330 receives the message and sets transmit power levels for its DPDCH and/or DPCCH based on the selected TPR. In one embodiment, the transmit powers of the DPDCH and DPCCH may be adjusted as follows. The current total transmit power remains the same but the allocation thereof is changed such that the pilot and traffic transmit powers correspond to the selected TPR. For example, the transmit power for the DPDCH and DPCCH may be set using in the following equations:

DPDCH transmit power=TPR*total transmit power/(TPR+1) (1)

DPCCH transmit power=total transmit power/(TPR+1) (2)

### Suppose the total transmit power is 10 Watts and the TPR is 5.33. Using equations (1) and (2), the transmit power levels for the DPDCH and DPCCH would be 8.42 Watts and 1.58 Watts, respectively.

Alternately, the transmit powers of the DPDCH and DPCCH may be adjusted by maintaining the current DPCCH transmit power and adjusting the current DPDCH transmit power, if necessary, such that the DPCCH and DPDCH transmit powers correspond to the optimum TPR. Or the current DPDCH transmit power remains the same and the current DPCCH transmit power is adjusted, if necessary, such that the DPCCH and DPDCH transmit powers correspond to the optimum TPR.

In another embodiment, RNC 310 or Node B 320 may set the total, DPDCH and/or DPCCH transmit powers. A message is sent to UE 130 indicating the set total, DPDCH and/or DPCCH transmit powers. Alternately, the message may indicate how much to increase the DPDCH and DPCCH transmit powers. Or the message may indicate the TPR and total transmit power (or DPDCH or DPCCH transmit powers).

In step 440, UE 330 transmits the speech frames and pilot signal over the DPDCH and DPCCH using the transmit power levels set in step 435. From step 440, flowchart 400 continues to step 415 where the DPDCH and DPCCH transmit powers are continuously adjusted in accordance with inner and outer loop power control. Traffic channel activity measurements will continuously be updated, and the TPR can be adapted accordingly to minimize the total transmit power for UE 330, i.e., steps 410-450 are repeated.

Note that steps 420-440 have been described as occurring after the DPDCH and DPCCH transmit powers have been adjusted via inner and outer power control in step 415. In another embodiment, these steps may, for example, occur concurrently with step 415 or before step 415.

Although the present invention has been described in considerable detail with reference to certain embodiments, other versions are possible. Therefore, the spirit and scope of the present invention should not be limited to the description of the embodiments contained herein.

1. A method of setting transmit power in a wireless communications system comprising the step of:
setting transmit power levels for a traffic channel and a pilot channel based on an activity level of the traffic channel.

2. The method of claim 1, wherein the transmit power levels of the pilot channel and the traffic channel are set using a message indicating a traffic to pilot ratio (TPR) based on the activity level of the traffic channel.

3. The method of claim 2, wherein the transmit power levels of the traffic and pilot channels are set in a manner corresponding to the TPR.

4. The method of claim 3, wherein total transmit power is reallocated between the traffic and pilot channels to correspond to the TPR.

5. The method of claim 3, wherein the transmit power of the traffic channel is adjusted such that the pilot and traffic transmit powers correspond to the TPR.

6. The method of claim 3, wherein the transmit power of the pilot channel is adjusted such that the pilot and traffic transmit powers correspond to the TPR.

7. The method of claim 1, wherein the transmit power levels are set such that a ratio between the transmit power levels for the traffic channel and the pilot channel (TPR) is higher for a lower activity level traffic channel and lower for a higher activity level traffic channel.

8. A method of controlling transmit power at a transmitting entity comprising the steps of:
determining a traffic to pilot ratio (TPR) using an activity level of the traffic channel, the TPR indicating relative transmit power levels between the traffic and pilot channels;
transmitting a message to the transmitting entity indicating to the transmitting entity a manner of setting its transmit power based on the TPR.

9. The method of claim 8, wherein the determined TPR would minimize a total transmit power associated with transmitting entity.

10. The method of claim 8 comprising the additional step of:
prior to the step of determining the TPR, determining the activity level of the traffic channel.

11. The method of claim 10, wherein the activity level of the traffic channel is determined using a voice activity detector.

12. The method of claim 10, wherein the activity level of the traffic channel is determined using a Transport Format Combination Indicator (TFCI).

13. The method of claim 8, wherein the message indicates the TPR.

14. The method of claim 13, wherein the message further indicates a total transmit power.

15. The method of claim 8, wherein the message indicates transmit power for the pilot and/or traffic channels.
